(19) United States
(12) Patent Application Publication
(10) Pub. No.: US 2009/0172520 A1
(43) Pub. Date: Jul. 2, 2009

(54) METHOD OF MANAGING WEB SERVICES USING INTEGRATED DOCUMENT

(75) Inventor: Young real Kim, Daejeon (KR)

Correspondence Address: AMPACC LAW GROUP, 3500 188th St. SW, Lynnwood, WA, 98037, US

(73) Assignee: KSEEK CO., LTD., Daejeon (KR)

(21) Appl. No.: 12/340,770

(22) Filed: Dec. 22, 2008

(30) Foreign Application Priority Data
Jun. 30, 2006 (KR) 10-2006-0060188
Jun. 29, 2007 (KR) 10-2007-0065785
Jun. 30, 2007 (KR) PCT/KR2007/003190

(51) Int. Cl. G06F 17/00

(52) U.S. Cl. 715/234

(57) ABSTRACT

The present invention is about the method of operating a web service by using the integrated document of web contents. The present invention provides a detailed method of operating a web service by using an integrated document. In addition, the present invention provides a detailed method of offering an ordinary electronic document as a web service as well as modifying and editing electronic document by an execution object of the web server. If the present invention is applied to the web service, the web contents can be managed conveniently. Also, any damage on the web service due to a loss of part of the web contents can be prevented by managing the web contents, which comprise a unit web service, as one integrated document.

### TECHNICAL FIELD

This invention comes under the internet technology field.

This invention also comes under the technology field of web service.

### BACKGROUND ART

Generally, the web service is provided by transmitting the web contents from the web server to the client. A program called, ‘web demon’ runs in the web server while a program called, ‘web browser’ runs in the client. Web demon opens the web service port (Usually port No. 80) and waits the web browser to request for the web contents. Web browser open a connection on the web server port, analyzes the URL (Uniform Resource Locator, the web address of the web contents), organizes the request information in accordance with HTTP (Hyper Text Transfer Protocol) and sends the request information to the web server. Detailed explanation on HTTP is written in RFC1945 (HTTP/1.0), RFC2068 (HTTP/1.1). URL is comprised of information such as the protocol, web server address, connection port No. and URI (Uniform Resource Identifier).

The existing web service has been operated by the web contents, which are individually saved in the web server. Such mechanism derives from the idea that web contents such as HTML document are manually controlled. As time goes by, the web service tends to develop into a more complicated form and is, therefore, handled by a specialized web editor software. As the number of web contents involved in the web service increases, a lot of problems emerge in operating the web contents.

The existing web service has been operated based on the web contents, which exist in each individual file or other saving unit (such as file data in a database). If the saving unit is lost, the web service will be provided in an incomplete manner. Also, if the user doesn't check and delete the web contents, which lost the linkage with HTML context due to a modification on the web service, the web contents will remain in the web server and occupy the storage space. Also, if the user manages the web contents with a lot of files, there will be waste on the storage.

As another existing method, there is a way to switch the electronic document into web content files and locate them on the web server. By using this method, the user can provide the details of the electronic document in the form of a web service. However, if part of the web contents is modified, the same effect cannot be applied to the original electronic document. Also if the electronic document is switched into multiple web contents, a lot of problems will emerge in operating the web service by the web contents, which are independently managed.

As another existing method, there is a way to display an electronic document that web browser which is transmitted the electronic document runs an execution object corresponding to the electronic document. This method requires the execution object to be installed in the client. Also, the client can be disturbed by a virus or worm while the execution object is running.

As another existing method, there is a way to display the electronic document that an integrated document is displayed on web display without installing an execution object. This method allows the Java Applet or Active-X control be downloaded and executed in response to the targeted integrated document. As the entire integrated document is downloaded from the server and run by the client's execution object, this technology is different from what the present invention offers.

As another existing method, there is a way to save a data as a electronic document automatically on the web server. This method is different from what the present invention offers. Said technology enables an electronic file configuration through a single system. But the present invention is different from said technology, because the methods of editing, modifying, replacing and eliminating part of the web contents from the integrated document, which is an example of this invention, are characterized by each step that constitutes the integrated document based on interaction between the web browser and client, and the transport of web contents.

As another existing method, there is a way to save a file of MIME or MHTML type. MIME refers to a method that integrates multiple document to send e-mails from ESMTP (RFC822). MHTML is an extended version of MIME technology covering the HTML field and is explained in detail in RFC2110, RFC2557.

MHTML technology is used to safely transport the web screen by using an electronic mail service or save the currently displayed web screen in some web browsers into one file. MTHML prepares an integrated document in the form of MIME by using web contents such as HTML or image that constitutes the web screen. This technology is different from that of the invention, which is designed based on the interaction between the client and web server. The user can form a web screen by letting the “*.mht”-type file approach to URL. But such method is supported only few web browser. The request for “*.mht” document by URL is different from the web service operation presented in this invention as it send the entire self-data to the client without any separation or conversion of the document and directly displays them through the client's browser.

To interpret the linkage information between the contents included in the MIME document, the user should go through decoding and processing stages that are needed after reading the entire document and classifying them in each sector around the boundary code. Especially, information on the size of contents is not directly recorded, so the size of the contents needed to be measured by another means. Given that the number of contents such as moving pictures and images is increasing recently, those contents aren't appropriate for being utilized in the web service operation. In addition, under the MIME technology, contents are indicated and classified in the form of 7 bit. Therefore, the technology can deteriorate the processing speed and waste the storage space compared to ordinary electronic document.

Also, the contents of MIME don't separately manage the size and final modification date, which are the main characteristics of the web contents. For this reason, the ordinary web browser can't use the cash function that is applied to the web contents to improve the presentation speed of web screen. So, the web browser is not suitable to be used as a desirable mean of web service operation.

### DISCLOSURE OF INVENTION

### Technical Problem

The present invention aims to solve technical problems such as defining the format of an integrated electronic document to organize the web contents, which participate in constituting a unit web service, as an integrated document file (or file data in a database) as well as organizing the web contents as an integrated document and save them as a file or other saving unit (such as file data in a database). In particular, the present invention faces technical problems of acquiring the web contents, which are subjected to integration, and converting the web linkage between web contents into a combined relation of integrated document.

In addition, the present invention aims to solve technical problems of separating the integrated document into the original web contents, so that the web server can provide unit web service to the client. In particular, the present invention faces technical problems of extracting the HTML context from the integrated document, so that the client can recognize each content as web contents from the combined information of the integrated web contents and request the web server for it. Also the present invention aims to solve technical problems of extracting the corresponding web contents from the integrated document upon request for each web content and sending it to the client.

In addition, the present invention aims to solve technical problems related to the method of web service supply such as separating an electronic document into each content, converting the content into web contents, and sending the web contents to the client.

In addition, the present invention aims to solve technical problems related to the method of converting the web contents, which participate in constituting a unit web service, into a specific electronic document type and saving them as an individual file or other saving unit.

In addition, the present invention aims to solve technical problems related to the method of modifying part of the web contents, which are included in the electronic document, by an execution object of web server upon request of the web browser.

### Technical Solution

The present invention can solve technical problems by defining the format of an integrated electronic document file to organize the web contents, which participate in constituting a unit web service, as an integrated document under an individual file or other saving unit (such as a file data in a database) as well as managing the web contents, which are saved as a file or other saving unit after being organized as an integrated document. In particular, the present invention intends to solve technical problems by acquiring the web contents, which are subjected to integration, and converting the web linkage between web contents into a combined relation of integrated document. In addition, the present invention intends to solve technical problems by designating information such as the size, final modification date and identification code of the web contents, in preparations for their application.

Also, the present invention intends to provide a technical solution by restoring the web contents from the integrated document, so that the web server can provide unit web service by restoring the integrated document as web contents. In particular, the present invention intends to provide technical solutions by converting the HTML context, so that the client can recognize each content as web contents from the combined information of the integrated web contents and request the web server for it as well as extracting and transmitting the corresponding web contents from the integrated document upon request for each web content.

In addition, the present invention intends to provide the method of web service supply such as separating an electronic document into each web content before converting and transmitting it.

In addition, the present invention intends to provide the method of converting the web contents, which participate in constituting a unit web service, into a specific type of electronic document and saving them under an individual file or other saving unit.

In addition, the present invention intends to provide the method of modifying part of the web contents, which are included in the electronic document, by an execution object of web server upon request of the web browser.

### ADVANTAGEOUS EFFECTS

By organizing a web service based on the present invention, it is possible to provide a web service with little number of integrated document. By managing the correlated web contents through a unit of integrated document, it is possible to eliminate the existing web contents, which lost correlation after being modified, from the integrated document. Also, by utilizing the basic information of web contents within the integrated document, it is also possible to manage separate information such as the total access to the web contents. By lowering the risk of losing the web contents, it is possible to prevent any damage on the web service.

By organizing a web service based on the present invention, it is possible to look through electronic document via a web browser without running another S/W (such as a ActiveX control or a Java applet). It is possible to minimize any infection from virus or worm that derives from the process of running the execution object.

By organizing a web service based on the present invention, it is possible to edit or modify the electronic document by using the execution object of web server.

By using the present invention, it is possible to design a web document with an ordinary word processor instead of a web document editing SAV and offer a web service.

### BRIEF DESCRIPTION OF THE DRAWINGS

FIG. 1 is a view illustrating the construction of web contents into an integrated document;

FIG. 2 is a view illustrating the conversion of an integrated document into web contents and the transmission of it;

FIG. 3 is a view illustrating the conversion of an electronic document into web contents and the transmission of it;

FIG. 4 is a view illustrating the conversion of an electronic document into web contents and the transmission of it;

FIG. 5 is a view illustrating the modification on an electronic document from a web server;

FIG. 6 is a reference of a desirable implementation of the present invention;

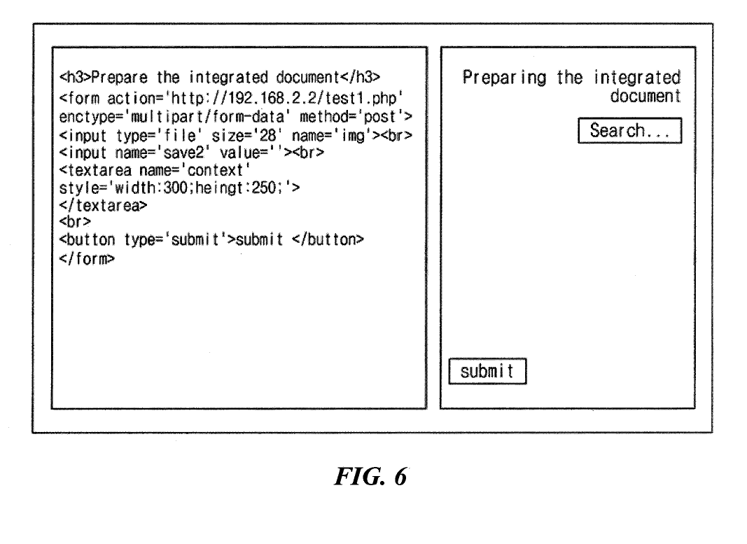

FIG. 7 is a reference of a detailed example of the present invention.

### BEST MODE FOR CARRYING OUT THE INVENTION

In the present invention, the web service is provided as follows: If the client asks for web contents, the web server sends the web contents to the client accordingly. Also, with regard to the client's request and the method of data transmission, the web server makes a response by saving new web contents. In the web server, a web demon is equipped and being executed. Web demon is organized in a way to directly provide the web service or let the execution object provide the web service.

For a detailed description of the present invention, the terminologies are defined as follows.

“Unit web service” means a service carried out by the client that constructs data on its web browser after receiving the requested web contents from the web server.

“Execution object” means a process or an execution module (such as a runnable script or a binary data) which can be executed on the web server or the client.

“Web content” means text data (such as HTML, XHTML, DHTML, XML, SGML, MHTML, CSS, JavaScript, etc). Also, it means binary data (such as image, flash, movie clip, music, multimedia and other objective data). Also, web content means a general term for execution object that can create such kinds of data (text or binary).

“HTML context” means a data such as HTML, XML, XHTML, MHTML, CSS, SGML, JavaScript that can embody the context of web service among the web contents. Also, HTML context means a general term for execution object that can create such kinds of data.

“Integrated document” means the result of combining and constructing the web contents, which participate in the configuration of a unit web service, along with the linkage information between the web contents which exist in an individual file or other saving unit. Integrated document is usually saved as an individual file but sometimes can be saved in the database. Also, integrated document can exist in file format and be attached to other data.

“Web address” means a URL (Uniform Resource Locator), which is a general term for absolute and relative addresses.

“Web linkage” is a linked relation between HTML context and other web contents.

Refer to the example of designating a web address in a src attribute of <img> tag. The client analyzes the HTML context and src attribute of <img> tag and, then, includes the corresponding web contents in the configuration of web service. Such work is the basis of forming a linkage between an independent web content and a unit web service. Designating a web address in a href and src attributes such as <object>, <embed> and <script> in addition to <img> tag is another model example of web linkage. Regarding a unit web service, the web contents, which are constructed by an execution object such as a script that can be executed in the HTML context, are regarded as having web linkage with HTML context. For example, configurating a web service after receiving the requested web contents from the web server by using a Javascript sentence is also regarded as a web linkage.

“Combined relation” is a relation combined by information between web contents, which are saved as an integrated document. Combined information include the type of each web content, location of combination with HTML context, stored location from the integrated document, name, size, final modification date, identification code and location of combination. Identification code and size are the key information, which help extracting the contents within the integrated document promptly. While linkage is a relation between web contents whose web linkage is dispersed in the web server, the combined relation is a relation between internal contents from a unit integrated document. The terminology, “combined relation” is used as it has a stronger meaning than linkage relation when constructing multiple contents into one integrated document.

“Identification code” is a data composed of information that can identify the web contents saved as an integrated document. Each web content that exists in one integrated document has its unique identification code. Identification code can be created from a consecutive number of web contents or data that derive from a consecutive number. Also, an identification code can be created by deriving from the basic information of web contents (size, location of combination from HMTL text, stored location from an integrated document, registration hour, attribute, type, name, etc). Also, an identification code can be created between web contents by other methods without being duplicated.

“Electronic document” is a document or document file (*.doc, *.hwp, *.xls, *.ppt, *.pdf, *.odf and other file types) created by a specialized SAV, which is widely used for the purpose of word processor, spreadsheet, presentation and other software for printing, compared to web contents that are directly displayed on the web browser. Electronic document is composed of various contents and managed under an individual file. Also the electronic document is special for being composed of 8 bit binary in order to occupy small storage space. In the present invention, electronic document is also called as ‘integrated document’ as it has the same characteristics of an integrated document.

“Attribute” is all kinds of attributes of web contents. Web contents of image sort have a size attribute of horizontal and vertical pixel units.

“Display attribute” is a designated to display the web contents on the web screen. For example, the display attribute of a HTML context, “<img src=‘test.gif width=‘30’ height=‘20’>” contains a designated width and height. Such display attribute may not coincide with the actual attribute of test.gif. In this case, the web browser should correct and display the proper attribute.

“List of linkage information” is an array of data structure that collects information such as the size, final modification date, type, attribute, identification code, linkage type and other characters with regard to every web content that will be included in the integrated document.

“SDF (Serialized Document Format)” is an electronic document format that is used for constructing an integrated document of web contents to facilitate the understanding on the present invention. SDF is saved under a file name of “*.sdf” type.

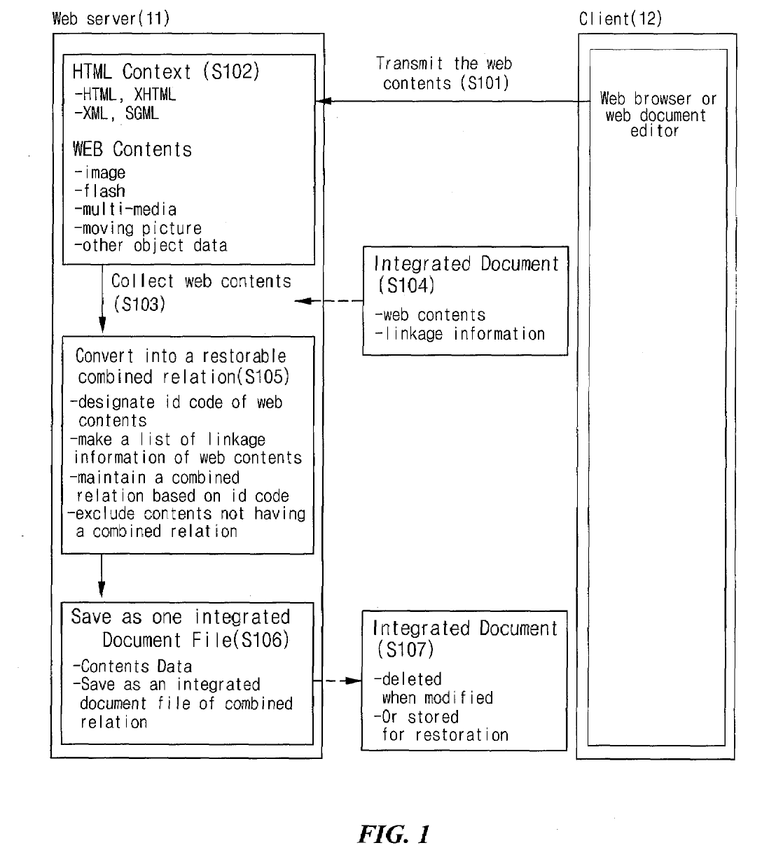

With regard to the present invention, the steps of integrating the web contents, which are sent from the client, into an integrated document are explained with reference to FIG. 1 as follows.

The present invention can be embodied by directly including the execution module in the web demon. Also, the present invention can be embodied by developing an execution object that acts on behalf of the web server and mounting it on the web server.

At the S101 stage, HTML context and other web contents are transmitted.

At the S101 stage, the client can send web contents to the web server based on the POST method. In order to do this, it is necessary to organize a web page designed to send web contents, in the client. The web page can incorporate both the sentence of “<form method=‘POST’ . . . action=‘ . . . upload.php’>” and “<input type=‘file’ . . . >”-type tag designed to send files. The present invention is embodied in a way that the client user selects the file that he/she wants to send and click the submit button while the web server can receive the file by organizing an execution object that responds to the “action” attribute of <form> tag. If the file is not the one, which independently exists in the client, the web page can be created through <textarea>, <input> so that the client user can send the information he/she entered to the web server. Also, it is possible to use a technical example of sending the web contents from the client to the server through an execution object such as Java Script. It is also possible to construct the S101 stage through an ordinary technical embodiment of AJAX or etc. Regarding the client's data transmission, the web server receives the web contents by embodying an execution object through an ordinary method using PHP, JSP and CGI. Regarding the file transmission method based on HTTP, it is recommended to use the “Form-Based File Upload in HTML” method, which is explained in detail at RFC1867.

The S101 stage can be designated as an essential order that simultaneously sends a simple web content to the web server and organizes that content into an integrated document on the web server. As an example of implementation, it is possible to send a file name of an integrated document to the web server by using am “<input name=‘save_to_file’ value=‘new.sdf>”-type sentence and let the file name of the web contents that exist in the web server be sent by using an <input> tag. The execution object of the web server designates the file received from the client as an integration target.

At the S102 stage, the object of web contents are prepared. The execution object of the web server makes the web contents, which have web linkage between HTML context, as the object to be integrated.

As an example of implementation of S102, the list of linkage information of the web contents, which is subjected to integration, is prepared after analyzing the web linkage. The linkage between HTML context and web contents can be obtained by analyzing the web linkage between tag sentences such as “<img>”, “<embed>”, “<script>”, “<object>”, “<applet>”, “<link>”. The object to be integrated must be selected among the web contents that have a web linkage with HTML context. The web contents participate in a unit web service, such as image, movie and flash, must be selected as an object to be integrated. Also, the list of linkage information must be prepared after examining information such as the size, name, type, final modification date and URL address of the web contents. The type of the contents can be designated as MIME type, which is ordinarily used in the web server, or by inferring from the extension if there is a file name.

At the S103 stage, the web contents, which respond to the list of linkage information, are collected. The web contents are collected in a way as follows: Reading the files of web contents with reference to the list of linkage information; Receiving web contents from the client at the S101 stage; Acquiring the web contents from another server; Or extracting the web contents from an existing integrated document in the web server (S104).

At the S105 stage, the linkage of web contents is reorganized. S105 is composed of detailed stages that examine the information of web contents, designate the identification code of web contents and convert the linkage of HTML context into a combined relation, which is based on the identification code.

The identification code is designated by a consecutive number, a data derived from a consecutive number or a value that isn't duplicated between each web contents within a unit integrated document. Only one identification code should respond to one web content. Conversion to a combined relation is carried out as follows: Convert a sentence that has a web linkage designated from an HTML context into a combined relation, which is based on an identification code.

At the S106 stage, a content, which is converted into a combined relation, is organized and saved as one integrated document. The combined information, which is based on an identification code, and the web contents are organized as an individual file or other saving unit. In case of saving the integrated document as a file, the existing file with the same name is replaced by a newly integrated file (S107).

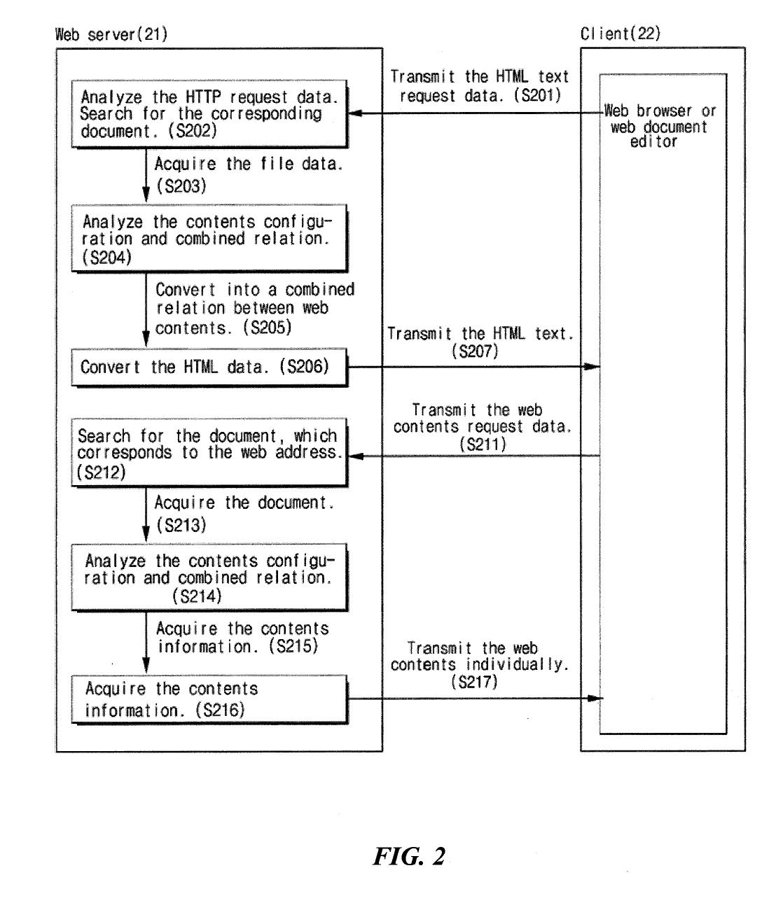

The steps of restoring HTML context and other web contents from the integrated document and sending them to the client, are explained with reference to FIG. 2 as follows.

At the S201 stage, the client requests to the web server for HTML context.

The client intends to complete the web screen by receiving additional web contents, which are required by the HTML context, from the web server. To carry out this process consecutively, execution objects of the web server should be organized.

At the S202 stage, the integrated document, which corresponds to the request for HTML context, is being searched. The client analyzes the data, which are transmitted for HTML context request, and searches for the corresponding integrated document. The corresponding integrated document should be found by analyzing URI and other information.

At the S203 stage, data from the integrated document are acquired. At the S204 stage, configuration of the integrated document is analyzed. To do this, the list of linkage information is acquired from the integrated document for analysis.

At the S205 stage, HTML context, which is extracted from the integrated document, is converted to have web linkage with the web contents of the integrated document. The HTML context is converted to have web linkage in a web address type, which is based on an identification code of the web contents.

According to another aspect of organizing a web linkage between HTML context and web contents, the client, which received the HTML context, requests to the web server for data by enforcing the execution object such as Java Script, and the web server provides the web contents accordingly. The web linkage can be organized by letting the client include the identification code data of the web contents into the requested information being sent to the web server as well as making the execution object from the web server side transmit the web contents, which correspond to the identification code that is extracted from the requested information.

At the S206 and S207 stages, HTTP features such as content-type, content-length and last-modified of HTML context are designated in HTTP header. Both HTTP header and HTML context will be sent to the client.

After receiving the HTML context, the client requests to the web server for additional web contents. At the S212 stage, the web demon finds the integrated document, which correspond to the requested web contents, acquires data from the integrated document (S213) and analyzes the configuration and combined relation of the web contents (S214). At the S211 stage, the identification code is extracted from the requested information, which is delivered to the web server. The web contents are acquired after searching for the identification code from the integrated document (S215), and transmitted to the client (S217). There is no need to enforce the S214 stage if the web contents whose size, combined location and features are discovered from the identification code can be directly extracted from the integrated document.

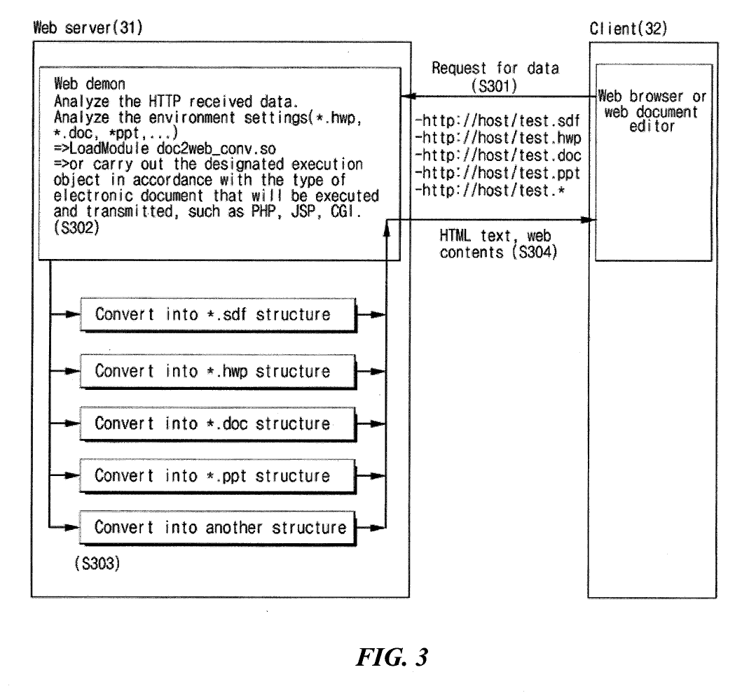

If the data to be sent to the client are specific type of electronic documents, the web server enforces the execution object, which corresponds to such data, to separate the data as web contents and send them to the client. The overall steps concerned are explained with reference to FIG. 3 as follows.

At the S301 stage, the client requests to the web server for data.

At the S302 stage, the web server enforces the execution object, which corresponds to the data, which turned out to be specific type of electronic documents.

At the S303 stage, the execution object being enforced in response to the specific type of document separates the document as web contents and sends them to the client rather than directly sending the document to the client.

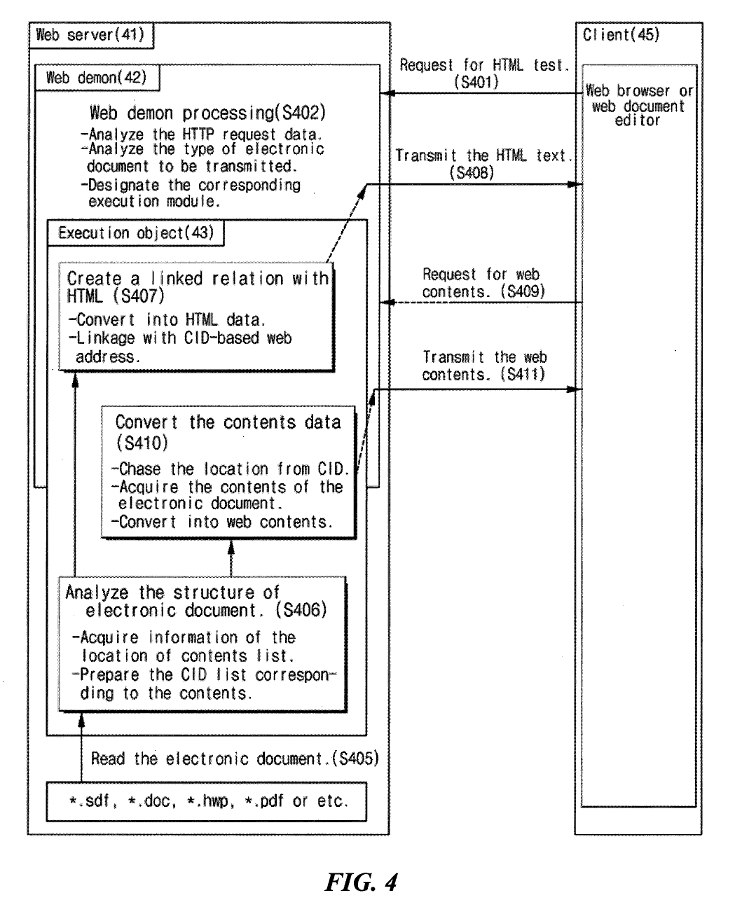

The steps of converting the electronic document, which exist in the web server, into web contents and sending them to the client are explained with reference to FIG. 4 as follows.

The web server (41) is comprised of the web demon (42) and execution object (43), and the electronic document are located in the directory path accessible by the execution object. The client (45) has a web browser that can ask the web server through a HTTP protocol to provide data.

At the S401 stage, the web browser requests to the web server for HTML context. Accordingly, the web demon designates the execution object and make a request. The execution object extracts the electronic document data (S405), creates the HTML context (S407), which has converted into a linkage through structural analysis on the electronic document (S406), and send it to the client.

After receiving the HTML context, the web browser requests for additional web contents (409) to complete the web service. Accordingly, the web demon executes the execution object. The execution object extracts the identification code from the client's requested information. Then, the execution object acquires the electronic document (S405) and analyzes their structure (S406) to acquire the basic information of the contents, which correspond to the identification code (S406). After acquiring the above contents by tracing their location from the electronic document, the execution object converts the contents into web contents (S410) and sends them to the web browser (S411). Such example of FIG. 4 can be carried out with reference to the format of the relevant electronic document as well as the procedure presented in the example of carrying out FIG. 2.

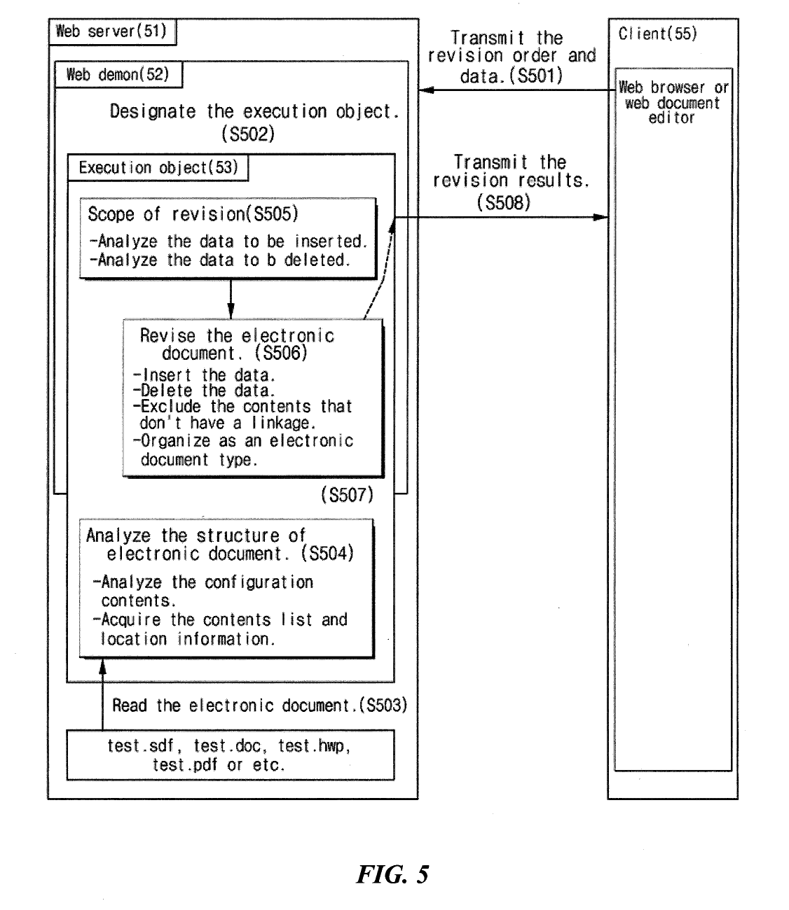

FIG. 5 is another example of carrying out the present invention. The steps of modifying the details of the electronic document through the enforcement of the execution object of the web server upon the client's request, are explained as follows.

At the S501 stage, the client sends the revision orders or contents. The web demon designates and enforces the corresponding execution module (S502). The execution module acquires the contents, which comprise the electronic document, from the original electronic document (S503) and analyzes their structure. Then, the execution module carries out the detailed process of the revision order (S506) by analyzing the revision order and additional contents (S505) and reorganizes those contents into an integrated document with an electronic document format.

### Mode for the Invention

As the model example of carrying out the present invention with reference to FIG. 1, the steps of organizing the HTML, which from the client, and image files, which has a web linkage with the HTML, into one integrated document, are explained as follows.

It is presumed that the client has a web screen that contains the form of “<form action=‘http://192.168.2.2/testl.php’ enctype=‘multipart/form-data’ method=‘post’><input type=file name=‘img’><br><input name=‘save2′ value=”><br><textarea name=‘context’><textarea><br> . . . <button type=‘submit’> submit </button></form> the appropriately equipped web screen is on the right. On the web screen, there are areas to select web content files for uploading (file) and areas to make input for HTML (context) and file names of the integrated document (save2).

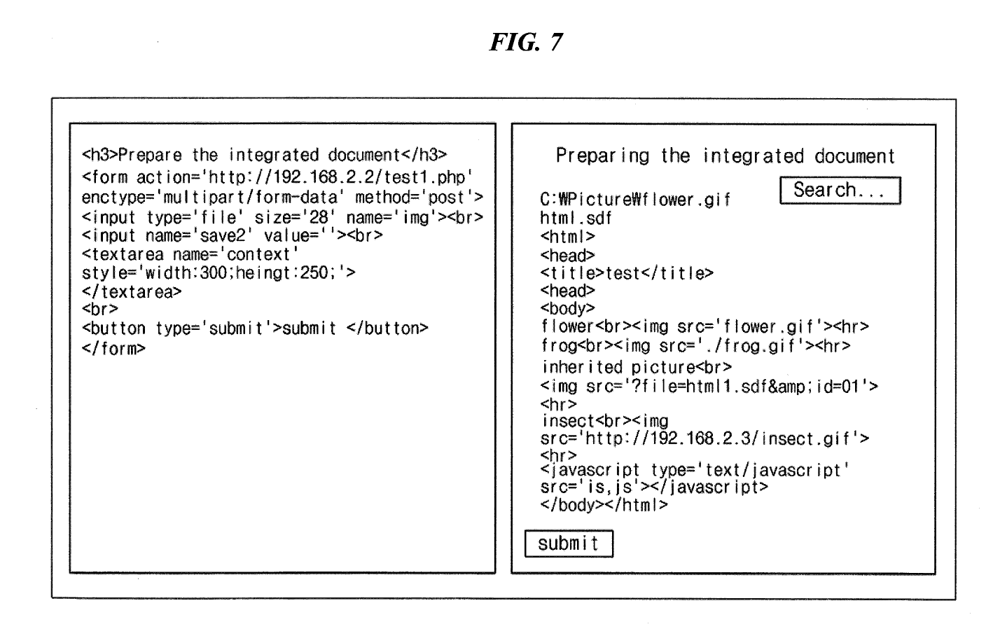

FIG. 7 is an example of carrying out the present invention,

The user illustrates assumptions that entered HTML, which contains the linked sentences such as “<img src=‘flower.gif>” (hereinafter referred to as “Linked Sentence 1”), “<img src=′./frog.gif>” (hereinafter referred to as “Linked Sentence 2”), “<img src=‘?file=htmil.sdf&amp;id=01’>” (hereinafter referred to as “Linked Sentence 3”), “<img width=“80” height=“50” src=‘http://192.168.2.3/insect.gif>” (hereinafter referred to as “Linked Sentence 4”), “<javascript type=‘text/javascript’src=‘is.js’></javascript> to as “Linked Sentence 5”). Also, from FIG. 7, the user illustrates an assumption that selected “flower.gif” file, which is located in the client, by clicking search from the web screen. Under the same situation of FIG. 7, if the user clicks the “submit” button, the client sends the HTTP header of POST method and the form data to the web server after searching for the IP address of 192.168.2.2 and creating a TCP/IP connection to the port of the web server. Accordingly, the web server executes the testl.php. In conclusion, the present invention can be carried out by organizing the testl.php in a way that satisfies the detailed process of the present example.

From the example of carrying out the present invention, testl.php is a program of PHP, which is a programming language for web development. As the client prepares HTTP protocol as POST, testl.php should follow the process of being organized as a file of integrated document, which is presented in this example, if REQUEST_METHOD is “POST”. As a normal method, data, which are received from the client, are analyzed and organized as elements. Elements refer to an arrangement that responds to the value entered by the user in each input area in relation to the name (name features) such as input or text area of the web screen shown in FIG. 7. The value of the received context element is the HTML, which was entered by the user in the client, and becomes the HTML context of the document to be integrated. The value of img element contains the file information whose the name, size and other features are usually analyzed.

testl.php analyzes the value of save2 input entry. If “html.sdf” is designated as shown in FIG. 7, the execution object, which activates in response to *.sdf file format, should be called. For easy embodiment of this example, the corresponding execution object is declared as the internal function of testl.php. The execution object responding to *.sdf should be organized to complete the following process.

Designate the information of HTML context as the first list of linkage information, and the identification code as “00”. Analyze the HTML context to carry out the process of equipping the list of linkage information of the web contents, which are subjected to integration and correspond to Linked Sentence 1, Linked Sentence 2, Linked Sentence 3, Linked Sentence 4, Linked Sentence 5. Add the basic information (name, size, form, etc) of the HTML context, which was transmitted from the client, to the list of linkage information. The final modification date of the HTML context is designated as the current time. Separate the value, which is designated in “src” feature, from each Linked Sentence through tags like <img> or <script>, <link>, which is included in the HTML context. Linked Sentence 1 is flower.gif. As flower.gif was transmitted from the client, information (name, size, form, etc) of the flower.gif image are added to the list of linkage information of the web contents, and the identification code is designated as “01”. Linked Sentence 1 of HTML context is replaced by “##[01]##” (hereinafter referred to as “Combined Sentence 1”). Linked Sentence 2 is “./frog.gif”. Figure out whether “frog.gif” exists in the “./” route. If “./frog.gif” exists, the necessary information (name, size, form, etc.) are examined from the file and added to the list of linkage information of the web contents, and the identification code is designated as “02”. The final modification date is designated as the current time. Information like file size or file type are obtained through comparison between the file system and extension. Information of file name except the directory path is designated, and Linked Sentence 2 of HTML context is replaced by “##[02]##” (hereinafter referred to as “Combined Sentence 2”). Linked Sentence 3 can obtain the stage of extracting the list of linkage information of the web contents from the integrated document, which already exists in the web server as mentioned in the example of carrying out the present invention from FIG. 2, as well as information (name, size, form, etc) relevant to the web contents from the stage of acquiring the web contents. The list of linkage information of the web contents is added, and the identification code is designated as “03”. The final modification date is designated as same as that of the web contents file. Linked Sentence 3 of HTML context is replaced by “##[03]##” (hereinafter referred to as “Combined Sentence 3”).

Linked Sentence 4 refers to a web content called, ′insect.gif, which exists in another web server (http://192.168.2.3/), and, therefore, a type of image. Open a connection in TCP/IP method on the web port of 192.168.2.3 server, transmit the HTTP header and receive the web contents of insect.gif. As another usual way to receive web contents is to use the wget command of Linux system or Unix system. If the web contents are successfully received, information (name, size, form, attribute, etc) of the web contents are analyzed and added to the list of linkage information, and the identification code is designated as “04”. Linked Sentence 4 of HTML context is replaced by “##[04]##” (hereinafter referred to as “Combined Sentence 4”).

The width and height features designated in Linked Sentence 4 are the display attribute for width and height of the contents. The display attribute of the contents can be obtained by analyzing the style feature of <img> tag or the css designation segment. If the display attribute of the image contents is different from the actual attribute of the image contents—especially if the actual attribute is far larger—as shown in Linked Sentence 4, many problems such as rising network loads, shrinking images on the web browser and falling image qualities can occur when transmitting an image content that has a larger attribute than the display attribute. Therefore, it is desirable to convert the image content suitable to the display attribute.

The image web content, which is equal to the display attribute, can be created by using a normal image-related library or execution object that supports the conversion of image attribute.

The image content, which is newly created in compliance with the display attribute, is added to the list of linkage information, and the identification code is designated as “@04”. Linked Sentence 4 is replaced by “##[@04]##” (hereinafter referred to as “Combined Sentence @4”).

Another method of responding to the display attribute designated in Linked Sentence 4 is to replace the Linked Sentence 4 by “##[04;opt:80×50]##” (hereinafter referred to as “Combined Sentence 4#”) and designate the identification code of the original image content as “04”. Such method is explained in the example of carrying out the present invention in FIG. 2.

Linked Sentence 5, which is similar to Linked Sentence 2, examines is.js file to add it to list of linkage information and designate the identification code as “05”. Then, Linked Sentence 5 is replaced by “##[05]##” (hereinafter referred to as “Combined Sentence 5”). The size of HTML context can be changed due to the replacement of each Linked Sentence. Therefore, it is necessary to remeasure the size of HTML context from the list of linkage information and designate it. Accordingly, the web linkage between individual web contents, which comprise the web service, is converted into a combined relation between contents.

In case of carrying out the process of restorable conversion such as encoding and compression on each content, a conversion feature is designated on the linkage information of the relevant content, and the size of the converted content is designated. If necessary, it is possible to carry out the process of restorable conversion such as encoding and compression on the list of linkage information afterwards.

To save a number of web contents into one integrated document file, a new file is created in the name of “.html.sdf.tmp”. With regard to the newly created file, the size of the list of linkage information is saved as 8 byte of binary. Then, the list of linkage information of the web contents is saved. After saving the web contents in the order of the list of linkage information, the file is closed. Accordingly, when the temporary integrated document file is completed, the file name of “.html.sdf.tmp” is changed into “html.sdf”. If a “html.sdf” file already exists, change it into “.html.sdf.bak” file and leave a backup file. Change the file name of “.html.sdf.tmp” into “html.sdf”.

The steps of organizing a web service by using an integrated document, are explained with reference to FIG. 2 as a model example of carrying out the present invention as follows.

To help easy understanding, the method of offering a web service from “html.sdf”, which is presented in the example of FIG. 1, are described.

If it is presumed that the client calls the address of “http://192.168.2.2/test2.php?file=html.sdf”, the web server will call test2.php as an execution object. Therefore, this example of carrying out the present invention can be completed by organizing test2.php in accordance with the process of this example.

If REQUEST_METHOD is “GET”, the test2.php analyzes the QUERY_STRING value. QUERY_STRING is defined as a character string that exists after “?” from the URL. QUERY_STRING can be cut into each designation unit by ‘&’, and each designation unit can be cut into two sides by ‘=’c. The left side of the designation unit is called, “Factor Name” while the right side is called, “Factor Value”. The test2.php analyzes two factor values such as file and idstr, organizes the relevant web contents and sends them to the client. If the idstr factor value is not designated, the HTML, which is applicable to the HTML context of the web screen, should be extracted from the “html.sdf” and be sent to the client, in this step “html.sdf” file is designated in the “file”. The test2.php should organize as the execution object, which responds to the electronic document format of “*.sdf”, in accordance with the following process.

The execution object, which responds to the electronic document format of “*.sdf”, obtains the size of the list of linkage information by reading 8 byte from “html.sdf”. The execution object should allocate the memory buffer as much as the size and read the list of linkage information from “html.sdf”. From the example of FIG. 1, if the list of linkage information is converted through methods like compression and encoding, it goes through the restoration process such as decompression and decoding.

Information of the combined HTML context is recorded in the first list of linkage information of html.sdf. Read the HTML context as much as the size designated in the list of linkage information. HTML context of the integrated document contains the “##[Identification Code]##” form of Combined Sentence 1, Combined Sentence 2, Combined Sentence 3, Combined Sentence 4 (or Combined Sentence @4 or Combined Sentence 4#) and Combined Sentence 5.

Combined Sentence 1 should be replaced by “<img src=‘c?file=html.sdf& amp;idstr=01’>”.

Combined Sentence 2 should be replaced by “<img src=‘?file=html.sdf& amp;idstr=02’>”.

Combined Sentence 3 should be replaced by “<img src=‘?file=html.sdf& amp;idstr=03’>”.

Combined Sentence 4 should be replaced by “<img src=‘?file=html.sdf& amp;idstr=04’>”.

Combined Sentence @4 should be replaced by “<img src=‘?file=html.sdf& amp;idstr=@04’>”.

Combined Sentence 4# should be replaced by “<img src=‘?file=html.sdf& amp;idstr=04&amp!option=80×50’>”.

Combined Sentence 5 should be replaced by “<script src=‘?file=html.sdf& amp;idstr=05’></script>”.

The string of “&amp;” from each Sentence is replaced by “&” while the web browser analyzes URL. After the replacement, the content size of HTML is changed and, therefore, should be remeasured. Values such as the content-type, content-length and last-modified are designated based on the content size and form of HTML and transmitted along with the HTML contents to the client in accordance with the HTTP protocol.

With regard to Combined Sentence 1, Combined Sentence 2, Combined Sentence 3, Combined Sentence 4, Combined Sentence @4, Combined Sentence 4# and Combined Sentence 5, the client, which received the HTML context, requests to the web server for web contents from the following web addresses:

“http://192.168.2.2/test2.php?file=html&idstr=0 O1” (hereinafter referred to as “Contents Address 1”),
“http://192.168.2.2/test2.php?file=html&idstr=02” (hereinafter referred to as “Contents Address 2”),
“http://192.168.2.2/test2.php?file=html&idstr=03” (hereinafter referred to as “Contents Address 3”),
“http://192.168.2.2/test2.php?file=html&idstr=04” (hereinafter referred to as “Contents Address 4”) or
“http://192.168.2.2/test2.php?file=html&idstr=@04” (hereinafter referred to as “Contents Address @4”),
“http://192.168.2.2/test2.php?file=html&idstr=04&amp;option=80×50” (hereinafter referred to as “Contents Address 4#”),
“http://192.168.2.2/test2.php?file=html&idstr=05” (hereinafter referred to as “Contents Address 5”).

Upon such request for web contents, the web server executes the test2.php.

Accordingly, the client's web service screen is successfully completed after the test2.php is organized to send web contents to the client in response to the request using the aforementioned Contents Address 1, Contents Address 2, Contents Address 3, Contents Address 4, Contents Address @4, Contents Address 4# and Contents Address 5.

The test2.php can obtain the identification code, which is designated as idstr factor value by analyzing the QUERY-STRING as mentioned above. Also the test2.php should open the html.sdf file and find the contents information, which correspond to the identification code, from the acquired list of linkage information. If the identification code is “01”, the corresponding web content is “flower.gif” that is designated in the second list of linkage information. The location of flower.gif within the integrated document is determined by the total amount of the size of the list of linkage information (8 byte), actual size of the list of linkage information and the size of the web content, which was designated ahead of the flower.gif. The web content can be acquired by reading it as much as the size of flower.gif from the location of the calculated content.

The extracted flower.gif web contents are subjected to decompression or decoding according to their features designated in the list of linked information. If the size is changed during such process, the contents information should be revised to reflect the new size. Features of the HTTP header such as the content-type, content-length or last-modified should be designated and sent to the client. With regard to the remaining requests related to Contents Address 2, Contents Address 3, Contents Address 4, Contents Address @4, Contents Address 4# and Contents Address 5, the web contents should be extracted according to the procedure requested by Contents Address 1 and sent to the client. With regard to Contents Address 4#, the web contents corresponding to Contents Address 4 should be extracted according to the procedure of Contents Address 1. Then, a new image content should be created by using an execution object that can change the actual attribute of the image, and sent to the client.

As a model example of carrying out the present invention in FIG. 3, the steps of offering a web service in response to the types of electronic document, which exist in the web server, are explained as follows.

It is presumed that the client requests for the web contents, which correspond to URL as follows.

“http://192.168.2.2/test3.php?file=html.sdf”,
“http://192.168.2.2/test3.php?file=html.doc”,
“http://192.168.2.2/test3.php?file=html,hwp”,
“http://192.168.2.2/test3.php?file=html.pfd”,
“http://192.168.2.2/test3.php?file=html.ppt”.

Therefore, it is necessary to organize the test3.php, which will be executed by the web demon, in accordance with the process designated in FIG. 3. The test3.php should enforce the test3_doc.php executor by analyzing the QUERY-STRING if there are information of html.doc, which correspond to “doc”, the extension of html.doc. With regard to the type of file extension at this stage, corresponding executors such as sdf:test3_sdf.php, hwp:test3_hwp.php, ppt:test3_ppt.php, odf:test3_odf.php, xls:test3_xls.php, pdf:test3_pdf.php should be executed. Execution objects such as test3_doc.php, test3_ppt.php, test3_odf.php, test3_xls.php, test3_pdf analyze the file data of each corresponding extension. It is a trend that electronic document are recently being operated as open document format. Detailed analysis on file structure and conversion of contents into web contents should be realized with reference to the file format technical document. According to the process presented in the example of FIG. 2, the web contents should be transmitted after being extracted from an integrated document and being output.

With reference to FIG. 3, the web server can provide an electronic document as a web service in response to the request for an electronic document type web content. Examples of requesting an electronic-type web content are as follows.

“http://192.168.2.2/doc/test.sdf”,
“http://192.168.2.2/doc/test.doc”,
“http://192.168.2.2/doc/test.hwp”,
“http://192.168.2.2/doc/test.pfd”.

The ordinary web demon sends the electronic document itself, which corresponds to the URL, to the client through the HTTP protocol. However, if an execution object, which corresponds to a specific electronic document format, is designated and executed in a similar method and process presented in FIG. 3, a web service can be provided in a similar way presented in the example of FIG. 2.

This step can be carried out by means of direct making of a web demon, which embodies such system during the URL analysis process. Also this step can be be carried out by means of embedding a module, which can differentiate the extension and correspond to it, into a existing web daemon such as apache. The types of electronic document can be classified based on mime type in addition to extension. If the web demon provides a specific type of electronic document as a web service in accordance with the process presented in FIG. 3, the content-type of HTTP header should be designated as a content-type of newly converted contents rather than a content-type of the existing electronic document.

As a model example of carrying out the present invention with reference to FIG. 5, the steps of restoring the HTML and image data from one integrated document, which exist in the web server, and of sending these data to the client, and of realizing a web service, are explained as follows.

From the example of FIG. 1, it is possible to make revisions by replacing or deleting “flower.gif”, which is a web content included in “html.sdf”, and saving it as a new integrated document. This example can be completed by organizing the test5.php execution object in accordance with the following process. It can be presumed that the web screen is comprised of HTML designed for revision. If HTML contains sentences of “<form method=‘post’ action=‘http://hostname/test5.php?file=html.sfd& amp;idstr=01′ enctype=‘multipart/form-data’><input type=file name=‘file’><input name=‘com’value=”> . . . <button type=‘submit’> submit</button></form>”, the file selection area and the character string input area are set up, and the “submit” button is displayed on the web screen. The character string input area, which is “com” entry, is recognized as an input column for orders.

The user selects “flower2.gif”, which is presumed to be existed in the client, by entering “remove” order of the client and clicking the submit button or entering “change” order and clicking the search button. As a result of clicking the “submit” button, the client sends the requested data to the web server. The web server executes the test5.php execution object. The test5.php analyzes the requested data, confirms that REQUEST-METHOD is “POST” and conducts parsing on the requested data in an ordinary method. If the order designated in the corn entry is “remove”, obtain the HTML data after extracting the list of linked the web contents with reference to the example of FIG. 2. Remove the web content that establishes “01” value, which is designated in idstr, as an identification code, from the list of linkage information. In addition, after finding the sentence designated as “##[01]##” in HTML and deleting it, open a new file, organize an integrated document and save it as indicated in the concrete example presented in FIG. 1.

### INDUSTRIAL APPLICABILITY

A web server solution, which uses a web service method based on the integrated document, can be developed and released on the market or utilized as a hosting rental service of the aforementioned web server solution. More over, relevant web services can be established or offered as a rental service for internet web site operators who provide web server services. Sequence Listing Nothing relevant

1. A method of organizing web contents as an integrated document in a computer system, the computer implemented method comprising:
upon receiving a request from a client, converting the web linkage of the web contents that organize a unit web service into a combined relation based on an identification code; and
organizing information of the combined relation with each web content as an integrated document,
wherein the converting step and the organizing step each is performed using one or more processors associated with the computer system.

2. The computer-implemented method of claim 1,
wherein the converting step includes:
designating an identification code without duplication on every web content subjected to integration.

3. The computer-implemented method of claim 1,
wherein, in the organizing step, the web contents are constructed into the integrated document suitable to a predetermined electronic document format.

4. The computer-implemented method of claim 1,
wherein the organizing step includes:
compressing or encoding at least one web content.

5. The computer-implemented method of claim 1,
wherein, when a previously integrated document within a web server is referred to, web contents that have a web linkage to HTML text and exist within the previously integrated document are extracted and included in the integrated document in the organizing step.

6. The computer-implemented method of claim 1, further comprising:
creating new web contents suitable to the display attribute and including the new web contents in the integrated document when the display attribute of the web contents is different from that of the actual web contents during the analysis of HTML in the converting step.

7. A computer-implemented method in which a web server provides a web service to a client in a computer system, the computer-implemented method comprising:
a first step of transmitting HTML context, extracted from an integrated document upon receiving a request from the client, to the client after being converted into a web linkage based on an identification code; and
a second step of extracting an identification code from requested information, acquiring web contents corresponding to the identification code from the integrated document, and transmitting the web contents to the client, when a request from the client for additional web contents is received by the web server,
wherein the first step and the second step each is performed using one or more processors associated with the computer system

8. The computer-implemented method of claim 7,
wherein, in the second step, when the display attribute of the web contents is designated differently from the display attribute of the actual web contents in the above requested information, newly created web contents that are adjusted to be suitable to the display attribute of the web contents are transmitted to the client,

9. A computer-implemented method of providing a web service using an electronic document in a computer system, the computer-implemented method comprising:
receiving at a web server a first request from a client for information of web contents based on an identification code;
receiving at the web server a second request from the client for web contents included in an electronic document;
upon receiving the first and second requests, allowing an execution object of the web server to extract an identification code from the information requested by the client;
retrieving contents corresponding to the extracted identification code from the electronic document;
converting the retrieved contents into web contents; and
transmitting the web contents to the client.

10. A computer-implemented method of modifying an electronic-type integrated document in a computer system, the computer-implemented method comprising:
using one or more processors associated with the computer system, a step of allowing an execution object of a web server to reorganize the electronic-type integrated document by revising or modifying part of the contents included in the electronic-type integrated document, which already exists in the web server, deleting part of the contents, which are included in the electronic-type integrated document, or adding new contents to the electronic-type integrated document, upon the client's request.

11. A computer-readable medium for executing a method for organizing web contents as an integrated document stored, the computer readable medium comprising:
code for converting the web linkage of the web contents that organize a unit web service into a combined relation based on an identification code when a request from a client is received; and
code for organizing information of the combined relation with each web content as an integrated document.
